(19) United States
(12) Patent Application Publication
(10) Pub. No.: US 2024/0280080 A1
(43) Pub. Date: Aug. 22, 2024

(54) ELASTOMERIC SPRING AND AZIMUTH DRIVE WITH ELASTOMERIC SPRING

(71) Applicant: EFFBE GmbH, Bad Soden-Salmuenster (DE)

(72) Inventors: Michael Schäddel, Alzenau (DE); Wolfgang Spatzig, Chemnitz (DE); Andreas Kehr, Gruenendeich (DE)

(73) Assignee: EFFBE GmbH, Bad Soden-Salmuenster (DE)

(21) Appl. No.: 18/567,976

(22) PCT Filed: May 18, 2022
(86) PCT No.: PCT/EP2022/063369

§ 371 Date: Dec. 7, 2023

(30) Foreign Application Priority Data
Jun. 7, 2021 (DE) 10 2021 114 582.1
Jun. 23, 2021 (DE) 10 2021 116 293.9

(51) Int. Cl. F03D 7/02; F16F 1/40; F16F 3/087; F16F 15/08

(52) U.S. Cl. CPC F03D 7/0248; F03D 7/0204; F16F 1/40; F16F 3/0873; F16F 15/08; F05B 2260/902

(57) ABSTRACT

An elastomer spring for an azimuth brake of an azimuth drive for tracking a nacelle having a rotor relative to a tower of a wind turbine, may include an elastomer body made in one piece and having upper and lower sides facing in a spring direction of the elastomer body for transmitting spring forces in the spring direction, and a preload component connecting the upper and lower sides and having a concavely curved lateral surface.

### CROSS REFERENCE TO RELATED APPLICATIONS

This patent application is a U.S. national stage of International Application No. PCT/EP2022/063369, filed on May 18, 2022, which claims priority to German Patent Application No. 10 2021 114 582.1, filed Jun. 7, 2021, and German Patent Application No. 10 2021 116 293.9, filed Jun. 23, 2021. Each of these applications are incorporated herein by reference in its entirety.

### BACKGROUND

### Field

The present disclosure relates to an elastomer spring for an azimuth brake of an azimuth drive for tracking a nacelle with a rotor relative to a tower of a wind turbine. The present disclosure further relates to an azimuth brake and an azimuth drive for a wind turbine.

### Related Art

Wind turbines usually comprise a stationary tower, in particular one that is fixed to the foundation or the ground, on which a nacelle that can be braked and tracked by the wind is rotatably mounted about a vertical axis by means of a slewing ring. The nacelle has a rotatably mounted rotor hub around which at least one rotor blade of a rotor can rotate.

The task of the azimuth drive is to move the nacelle, and thus the rotor blade of the wind turbine rotor, to the optimum nacelle position for energy conversion depending on the wind direction. For example, ball slewing rings and electric drives are used. The slewing ring usually comprises a gear rim fixed to the tower with a face side gearing, also called an azimuth ring, on the face side of which several motors engage in a geared manner in order to move in a rotary motion relative to the azimuth ring and thus to track the nacelle.

For braking and securing the nacelle, for example in maintenance cases, several friction brakes distributed over the circumference of the azimuth ring are used, which essentially have a C-shaped structure and grip around the azimuth ring in a clamp-like manner so that they are in frictional contact with the upper and lower sides of the azimuth ring oriented in the vertical direction. The azimuth brake usually has sliding linings for contact with the azimuth ring. Furthermore, disc spring assemblies are provided for preloading the sliding linings in the direction of the azimuth ring. The amount of preload can be used to adjust the frictional resistance and thus the braking effect.

Conventionally, disc springs have a failure probability of approx. 1%. Depending on the type of wind turbine, up to 270 disc springs are used in wind turbines, so that the risk of damage to the azimuth drive is multiplied. The problem with disc spring assemblies is that if even one disc spring is damaged or fails, the complete preload of the assembly is suddenly lost. Consequently, the remaining load is distributed among the spring assemblies that remain intact, which are thus permanently overloaded, so that the damage process in the other disc spring assemblies accelerates. The wind turbine comes to a standstill and unscheduled maintenance procedures are required, which are costly.

Such azimuth drives and azimuth brakes are known, for example, from EP 0945613 B1 or WO 2015/082114 A1. EP 0945613 A1 and WO 2015/082114 A1 also disclose initial approaches to replacing the disc spring assemblies with alternative stores of potential energy, such as air springs, gas springs, elastomer springs or torsion springs.

In addition to the high risk of failure of the disc spring assemblies, the large space required and the high number of parts have proven to be disadvantages of the known azimuth systems.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 shows a section of an azimuth drive of a wind turbine according to the disclosure.

FIG. 2 shows a side view of an azimuth brake of the azimuth drive of FIG. 1.

FIG. 3 is a sectional view corresponding to line III-III from FIG. 2.

FIG. 4 is a sectional view corresponding to line IV-IV from FIG. 2.

FIG. 5 is a side view of an elastomer spring according to an exemplary embodiment of the disclosure.

FIG. 6 shows the elastomer spring of FIG. 5 in a compressed state, according to an exemplary embodiment of the disclosure.

FIG. 7 is a perspective view of the elastomer spring of FIGS. 5 and 6, according to exemplary embodiments of the disclosure.

FIG. 8 is a side view of an elastomer spring according to an exemplary embodiment of the disclosure.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, and components, have not been described in detail to avoid unnecessarily obscuring embodiments of the disclosure.

An object of the present disclosure is to overcome the disadvantages of the prior art, in particular to provide a more reliable and/or durable azimuth brake and/or azimuth drive.

According to this, an elastomer spring is provided for an azimuth brake of an azimuth drive for tracking a nacelle having a rotor relative to a tower of a wind turbine. The tower is usually stationary and/or fixed to the foundation. The elastomer spring may be used to build up a frictional force. In particular, the elastomer spring may be used to bring the sliding linings of the azimuth brake into contact with the azimuth ring in order to brake the nacelle during tracking relative to the tower of the wind turbine while building up a frictional resistance and thus a braking effect.

The elastomer spring according to the disclosure may comprises an elastomer body made in one piece. The elastomer body may be produced, for example, by polymerisation, polycondensation, polyaddition or vulcanisation. The elastomer material may, for example, be a cast elastomer, in particular polyurethane, such as Urelast.

The elastomer body may have an upper side facing in a spring direction of the elastomer body and a lower side facing in the spring direction of the elastomer body, which is opposite the upper side. The upper and lower sides serve to transmit spring forces in the spring direction. The elastomer body may, for example, comprise and/or be made of solid material. The elastomer body further extends in a longitudinal direction oriented parallel to the spring direction of the elastomer body. In the spring direction, the elastomer body may in particular elastically deform and compress. The elastomer spring can be adapted to apply and reduce the frictional force for braking the nacelle by utilizing the in particular elastic deformation, in particular compression and expansion.

The elastomer spring according to the disclosure may further comprises a preload component connecting the upper and lower sides and having a concavely curved lateral surface. It should be understood that the concavity of the lateral surface is to be understood when looking at the elastomer spring from the outside. When viewed in the opposite direction, i.e. from inside the elastomer body, the curvature of the lateral surface is convex. The preload component is made in one piece with upper and lower sides. The upper and lower sides may each be realized by substantially planar plates or disks. The lateral surface connecting the upper and lower sides may have a constant radius of curvature and/or be circumferentially closed with respect to the longitudinal direction of the elastomer body. Elastomer bodies as elastomer springs for azimuth brakes have proved to be advantageous above all because the elastomer springs, in contrast to disc spring assemblies, are characterized by excellent emergency running properties. This is because if an elastomer spring is damaged, the preload is never completely lost, so the elastomer springs can be replaced during scheduled maintenance.

One elastomer spring can replace a six-piece disc spring assembly, so the variety of parts can be greatly reduced and the risk of failure of the elastomer spring is also much lower than that of a six-piece disc spring assembly. Due to the structure of the elastomer body according to the disclosure, in particular due to the shape deviating from a purely cylindrical shape by means of the concavely curved lateral surface, the elastomer spring can be subjected to very high loads, in particular the viscoelastic effect can be exploited. As a result, the space required for the necessary deformation can also be minimized. In contrast to purely cylindrical elastomer springs, the structure according to the disclosure makes it possible to achieve the desired clamping force in standard azimuth brakes while retaining the available installation space. If standard cylindrical elastomer springs were used, the cross-sectional area of the spring elements would have to be multiplied, in particular increased by a factor of two or three, in order to generate the same sufficient clamping force. By omitting elastomer material in the portion of the lateral surface of the elastomer body, the material costs of the elastomer spring are reduced on the one hand, and on the other hand, the free space remaining on the lateral surface as a result of the concavity, which surrounds the lateral surface, offers a large yielding space for the elastomer material of the elastomer body, so that its deformation rate is increased.

The preload component, which may also be referred to as the deformation component, may be adapted to be preloaded and/or deformed, such as in particular elastically compressed or compressed, in particular in the spring direction, whereby it may generate a force, in particular a reaction force, such as in particular an elastic deformation restoring force, directed in the spring direction. The preload component can have a passive state, in which it is undeformed and/or not preloaded, and an active state, in which it is deformed and/or preloaded.

In an exemplary embodiment of the elastomer spring according to the disclosure, the preload component is adapted to elastically compress during compression in such a way that the curvature of the lateral surface decreases. In other words, when the elastomer body is compressed, its upper and lower sides are moved towards each other, which results in a particularly elastic deformation of the preload component in that the elastomer material of the preload component is compressed in the axial direction or spring direction, so that elastomer material is displaced radially outwards, which increases the radius of curvature of the lateral surface.

According to a further exemplary embodiment of the elastomer spring according to the disclosure, the preload component is further adapted to expand, in particular elastically, during deflection in such a way that the curvature of the lateral surface increases, whereby in particular the radius of curvature of the lateral surface decreases. When the preload component expands, the opposite effect occurs in relation to the compression described above.

It is clear that the degree of compression or expansion of the preload component can be adjusted or limited by its dimensions. The dimensions in axial and radial direction as well as the radius of curvature are relevant.

In another exemplary embodiment of the present disclosure, the preload component compresses during spring deflection to build up an elastic deformation restoring force in such a way that the elastomer body transmits the deformation restoring force as a preload force in the spring direction via the upper and lower sides. In other words, the particularly elastic compression of the preload component of the elastomer body can be used to generate a preload force via the resulting deformation restoring force, which the azimuth brake can use to brake the azimuth drive by building up frictional force.

In an exemplary further development of the elastomer spring according to the disclosure, the elastomer body has at least one further, in particular two or three further, in particular identically shaped preload component(s). The elastomer spring formed in this way can also be referred to as a sandwich construction. In particular, all the preload components are made in one piece with the upper and lower sides and/or with each other. The preload components may be arranged in series in the spring direction. The series arrangement of the plurality of preload components may be configured such that the individual preload components are independently deformable, in particular compressible and expandable. For example, the elastomer spring has a bellows or concertina-like deformation behavior.

According to an exemplary further development of the elastomer spring according to the disclosure, two adjacent preload components are separated from each other by a cutting disc, in particular a planar one, which remains substantially undeformed during compression and/or extension. The cutting discs are made in one piece with the preload components and/or the upper and lower sides. According to this embodiment, a bellows or concertina-like structure results, the deformation behavior of which is also similar to a bellows or concertina. The individual preload components compress and expand under load as the cutting discs and the upper and lower sides move towards and away from each other, respectively, depending on whether there is deformation or expansion.

According to another exemplary embodiment of the elastomer spring according to the disclosure, the cutting disc, in particular, the cutting discs, have the same shape and/or the same outer dimension as the upper and lower sides. The elastomer body may be rotationally shaped and/or axially symmetrical with respect to a center axis, both longitudinally and transversely viewed with respect to the cross-section of the elastomer body.

According to another aspect of the present disclosure, which may be combined with the preceding aspects and exemplary embodiments, an azimuth brake is provided for an azimuth drive for tracking a nacelle having a rotor relative to a tower of a wind turbine. Reference can be made to the preceding embodiments with respect to the basic construction, operation and arrangement of the azimuth brake in relation to the azimuth drive and the associated nacelle, rotor and tower components. The azimuth drive comprises an azimuth ring that is non-rotatably connected to the tower, which may be stationary and/or fixed to the foundation.

The azimuth brake according to the disclosure comprises a sliding disk in sliding contact with the azimuth ring and an elastomer spring, in particular according to the disclosure, for example formed according to one of the aspects or exemplary embodiments described above, for preload the sliding disk against the azimuth ring.

To apply a braking force to the azimuth ring, i.e. to brake the azimuth ring rotationally driven by the azimuth drive, a force can be applied to the sliding disk facing the azimuth ring by means of the elastomer spring in order to bring it into frictional contact with the azimuth ring or to amplify an existing frictional contact so that the azimuth ring is braked.

According to the further aspect of the disclosure, the elastomer spring may be made from a cast elastomer, in particular polyurethane, such as Urelast, and/or from a single piece, in particular in one manufacturing step and/or tool.

The basic advantages of using elastomer springs instead of disc spring assemblies are discussed above. Cast elastomers have proven to be advantageous for use in azimuth brakes in wind turbines in that they have a very low compression set, which is, for example, at least 10% or at least 15% lower than that of standard elastomer components and/or is, for example, 5%. Furthermore, cast elastomers are characterized by a high resistance to ageing. In the application in azimuth brakes, an ageing resistance of more than 20 years is given for cast elastomers. Polyurethane is also characterized by a high tensile strength of approx. 40 N/mm² and an elongation at break of approx. 500%. Compared to standard elastomers, this results in a significantly higher tensile strength as well as a significantly higher elongation at break, in particular by at least 1.5 times, 2 times or 2.5 times.

According to an exemplary embodiment of the azimuth brake according to the disclosure, the azimuth brake has a receptacle, in particular fixed to the nacelle, for the elastomer spring, in which the elastomer spring, in particular also the sliding disk, is translationally displaceable. In other words, the receptacle is provided in the nacelle itself or in a further component of the wind turbine connected to the nacelle, in particular in a rotationally fixed manner. The elastomer spring may in particular be displaceable in translation in the spring direction, so that the elastomer spring is displaceable in translation in the spring direction for compression and for expansion. The receptacle for the elastomer spring can be realized, for example, by a recess, in particular a cylindrical recess.

In an azimuth brake according to an exemplary embodiment of the present disclosure, the elastomer spring may have at least two clamping sections arranged at a distance from each other in the spring direction of the elastomer spring, which are in circumferential contact with the receptacle and are connected to each other via a circumferentially closed, concavely curved lateral surface. The clamping sections may be formed by the upper and lower sides of the elastomer spring. The clamping sections may define the maximum dimension of the elastomer spring transversely to its longitudinal direction, which is oriented parallel to the spring direction. In other words, the elastomer spring is in circumferential contact with the circumferential walls of the receptacle via the clamping sections. The elastomer spring need not necessarily be in contact with the recess base, but may be located at least in a compressed state at a slight distance therefrom.

In an azimuth brake according to an exemplary embodiment of the disclosure, when the elastomer spring is compressed to increase the preload force on the sliding disk and/or to apply a preload force on the sliding disk, the clamping sections rest on the receptacle in such a way that they are moved towards each other and the curvature of the lateral surface decreases. Due to the elastic compression of the elastomer spring, which occurs when the clamping sections move towards each other, the material of the elastomer spring is displaced radially outwards, which reduces the curvature of the lateral surface. The displaced material of the elastomer spring can thus expand or yield into a yielding space resulting between the inner wall of the receptacle and the lateral surface.

The preload force may be adjusted via a degree of compression of the elastomer spring, according to an exemplary embodiment. For example, the preload force and thus the braking force of the azimuth brake increases as the degree of compression of the elastomer spring increases, in particular linearly.

In another exemplary embodiment of the azimuth brake according to the present disclosure, the azimuth brake may further include a mechanical or hydraulic or pneumatic device for compressing the elastomer spring. For example, the device may be coupled to an electronic controller that controls the compression or expansion of the elastomer spring. For example, the device may comprise a screw. For example, the screw protrudes into the receptacle such that to compress the elastomer spring, the screw is increasingly screwed into the receptacle space such that the screw presses on one of the clamping sections and pushes it towards the other clamping section compressing the elastomer spring.

Furthermore, the present disclosure also provides an azimuth drive for tracking a nacelle with a rotor relative to a tower of a wind turbine. The azimuth drive according to the disclosure comprises at least one servomotor which drives, for example, an azimuth ring, and an azimuth brake which is formed according to one of the above aspects or exemplary embodiments and which may comprise an elastomer spring according to the disclosure.

According to the present disclosure, an elastomer spring for an azimuth brake of an azimuth drive of a wind turbine is generally provided with the reference numeral 1. An azimuth brake according to the disclosure is generally provided with the reference numeral 10 and the associated azimuth drive is generally provided with the reference numeral 100.

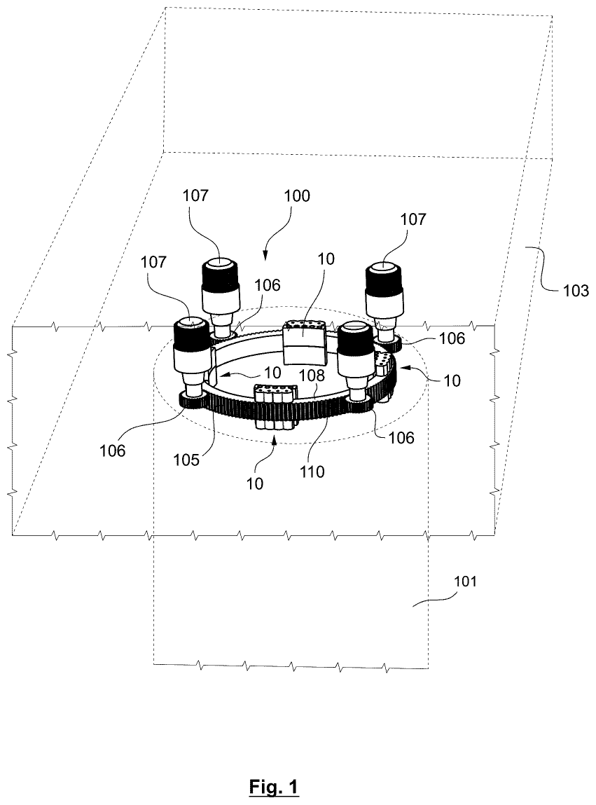

FIG. 1 shows a perspective sketch of a section of an azimuth drive 100 of a wind turbine. A wind turbine usually comprises a stationary tower 101 and a nacelle 103 rotatably connected to the tower 101. The nacelle 103 can be rotated about a vertical axis by means of the rotary connection in order to track the wind and decelerate the nacelle 103 and a rotor (not shown) rotatably mounted on the nacelle 103 with at least one rotor blade. In this way, the rotor blades are always in an optimal position for energy conversion in relation to the wind direction. In FIG. 1, the rotary connection between the tower 101 and the nacelle 103 is realized by the azimuth drive 100.

The azimuth drive 100 comprises a gear rim 105 with external gearing, also referred to as an azimuth ring, which is non-rotatably connected to the tower 101. The azimuth drive 100 also comprises a number of servomotors or electric motors 107, which are connected to the nacelle 103 in a rotationally fixed manner and engage in the external gearing of the azimuth ring 105 in a geared manner via a gear wheel 106 in each case, in order to set themselves in a rotational movement with respect to the azimuth ring 105 and thus move the nacelle 103. To brake the nacelle 103, the azimuth drive 100 in FIG. 1 also comprises four azimuth brakes 10 distributed evenly around the circumference of the azimuth ring 105. In FIG. 1, it can be seen that the azimuth brakes 10 each have a substantially C-shaped structure and grip around the azimuth ring 105 like a clamp. For braking the nacelle 103, a friction contact is formed between an azimuth brake 10 and an upper side 108 and a lower side 110 of the azimuth ring 105 viewed in the vertical direction, normally in the form of sliding linings 3 on the azimuth brake 10. To preload the sliding linings 3 in the direction of the azimuth ring 105 and thus to generate a frictional force between the azimuth ring 105 and the sliding linings 3, elastomer springs 1 according to the disclosure are used in the azimuth brake 10 in FIG. 1. In FIG. 1 it can be seen that an azimuth brake 10 has, due to the C-shaped structure, both sliding linings 3 and associated elastomer springs 1 which make frictional contact with the lower side 110 of the azimuth ring 105 and sliding linings 3 and associated elastomer springs 1 which make frictional contact with the upper side 108 of the azimuth ring 105. In this way, the braking effect of the azimuth brake 10 can be increased.

The use of elastomer springs 1 according to the disclosure for an azimuth brake 10 has proven to be advantageous because, in contrast to disc spring assemblies used in the prior art, the elastomer springs 1 are characterized by excellent emergency running properties. This is because the preload is not completely lost if an elastomer spring 1 is damaged, so it can be easily replaced at the next scheduled maintenance. In addition, the risk of failure of elastomer springs 1 according to the disclosure is lower than that of disc spring assemblies. The elastomer springs 1 according to the disclosure will be discussed below with reference to FIGS. 3 to 8.

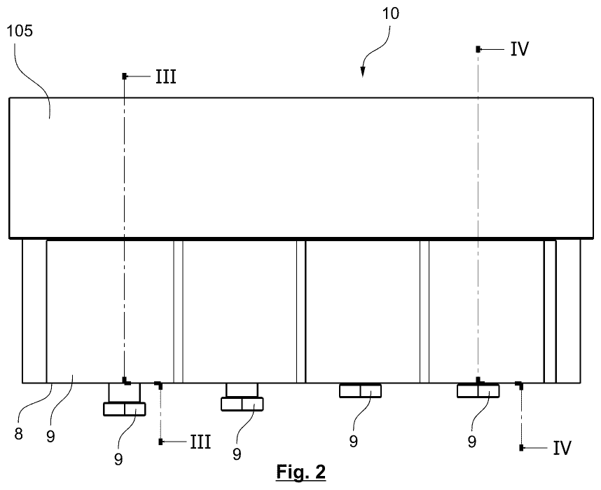

FIG. 2 shows a schematic side view of an azimuth brake 10 of the azimuth drive 100 from FIG. 1. The azimuth brake 10 in FIG. 2 represents the lower part of an azimuth brake 10 from FIG. 1, so that in FIG. 2 the braking force is generated via frictional contact with the lower side 110 of the azimuth ring 105. The azimuth brake 10 may additionally comprise the upper part of the azimuth brake 10 of FIG. 1, which generates a frictional contact with the upper side 108 of the azimuth ring 105, and is substantially identical in construction. However, the upper side of the azimuth brake 10 is not shown in the embodiment in FIG. 2.

The embodiment of an azimuth brake 10 according to the disclosure in FIGS. 2 to 4 comprises four sliding disks 3 in sliding contact with the azimuth ring 105 and four elastomer springs 1 according to the disclosure, each associated with one of the sliding disks 3 and described in detail later, for preloading the sliding disks 3 against the azimuth ring 105 to produce a frictional contact.

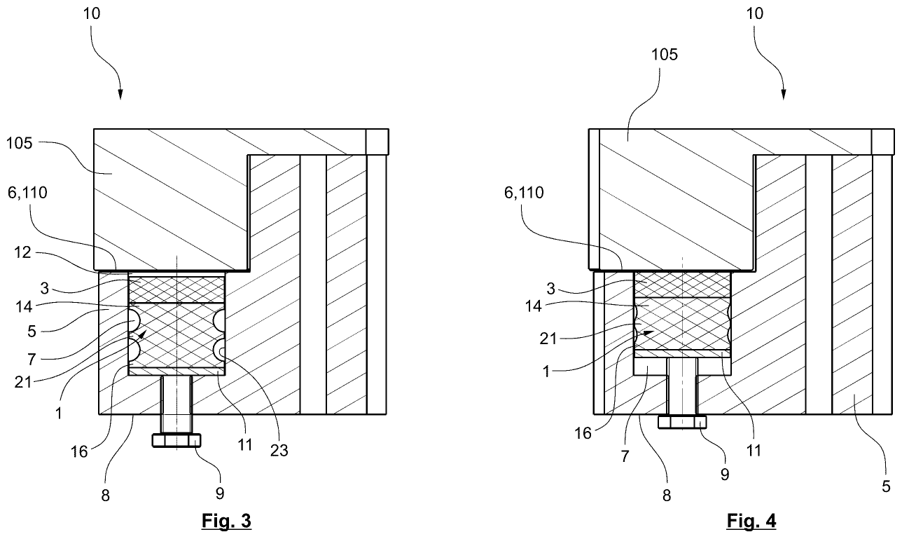

FIGS. 3 and 4 each show the azimuth brake 10 of FIG. 2 in a sectional view corresponding to lines III-III and IV-IV to illustrate the operation of an elastomer spring 1 or azimuth brake 10 according to the disclosure. In FIG. 3, an elastomer spring 1 is shown in an untensioned state, which guides the azimuth brake unit 10 associated with the elastomer spring 1 in not applying any braking force to the azimuth ring 105. FIG. 4 shows a further elastomer spring 1 in a tensioned state, guiding the azimuth brake unit 10 associated with the further elastomer spring 1 to apply a braking force to the azimuth ring 105 and slow down the nacelle 103. The preload force of the azimuth brake 10 or of an individual azimuth brake unit 10 is thereby adjustable via a degree of compression of the elastomer springs 1. The degree of compression of an elastomer spring 1 indicates how much the elastomer spring 1 can compress and determines the deformation restoring force that can be generated by the compression of the elastomer spring 1.

The azimuth brake 10 has a receptacle 5 for the elastomer springs 1 which is non-rotatably connected to the nacelle 103. In the embodiments in FIGS. 2 to 4, the receptacle 5 has an L-shaped structure and is arranged vertically below the azimuth ring 105 and above the tower 101 (not shown in FIGS. 2 to 4) in the wind turbine. The receptacle 5 thus adjoins the azimuth ring 105 with an upper side 6 and the tower 101 with a lower side 8. On the lower side 8 there is no direct contact with the tower 101 to allow the receptacle 5 to rotate relative to the tower 101. On the upper side 6 of the receptacle there is either no direct contact with the azimuth ring 105 either or the upper side 6 of the receptacle 5 and the lower side 110 of the azimuth ring 105 are formed in such a way that they do not impair rotation of the receptacle 5 relative to the azimuth ring 105, which is non-rotatably connected to the tower 101.

In the embodiment shown in FIGS. 2 to 4, the receptacle 5 has a cylindrical recess 7 for each elastomer spring 1, in which the elastomer spring 1 and the associated sliding disk 3, which is arranged in the vertical direction between the elastomer spring 1 and the azimuth ring 105, are translationally displaceable. The recesses 7 extend from the upper side 6 of the receptacle 5 facing the azimuth ring 105 into the interior of the receptacle 5. Via the translatory displaceability, it is possible for the elastomer spring 1 to compress in the recess 7. Furthermore, the translational displaceability makes it possible to ensure that when the elastomer spring 1 is in a relaxed state, as shown in FIG. 3, and no braking force is to be built up on the azimuth ring 105, there is no contact between the sliding disk 3 of the azimuth brake unit 10 and the azimuth ring 105, which would create frictional resistance when the nacelle 103 rotates. FIG. 3 shows that a gap 12 is formed between the sliding disk 3 and the azimuth ring 105 in the untensioned state. When the elastomer spring 1 is compressed, as shown in FIG. 4, it is first moved translationally in the direction of the azimuth ring 105 so that there is no longer a gap 12 between the sliding disk 3 and the azimuth ring 105 and only then is the elastomer spring 1 compressed. This creates a gap between the elastomer spring 1 and a recess base 25 of the recess 7. The gap 12 is dimensioned so that, on the one hand, it is large enough to ensure that there is no contact between the sliding disk 3 and the azimuth ring 105 when the elastomer spring 1 is in the relaxed state and, on the other hand, it is small enough to delay the braking effect as little as possible when the azimuth brake 10 or the azimuth brake unit 10 is actuated. The cylindrical recesses 7 have the same diameter as the elastomer springs 1, so that the elastomer spring 1 is in circumferential contact with the inner walls 23 of the recess 7.

In the embodiment shown in FIGS. 2 to 4, the receptacle 5 comprises a device for compressing the elastomer springs 1, which for each elastomer spring 1 has a screw 9 for compressing the respective elastomer spring 1. The screw 9 projects from the lower side 8 of the receptacle 5 into the receptacle 5 or cylindrical recess 7 in such a way that it is increasingly screwed into the receptacle 5 or cylindrical recess 7 to compress the elastomer spring 1 and presses on the elastomer spring 1. For uniform transmission of the force from the screw 9 to the elastomer spring 1, a disk 11 is provided between each of the screw 9 and the elastomer spring 1, which has the same external dimensions as the elastomer spring 1 and the recess 7. The disk 11 is pressed in the direction of the azimuth ring 105 by the screw 9 in the cylindrical recess 7 when the azimuth brake unit 10 is actuated to compress the elastomer spring 1 and create a preload force on the sliding disk 3. The elastomer spring 1 thus supports itself against the disk 11 of the receptacle 5 during compression to increase the preload force on the sliding disk 3. The elastomer spring 1 thus presses the sliding disk 3 against the azimuth ring 105 and the receptacle 5 or the nacelle 103 connected to it is braked.

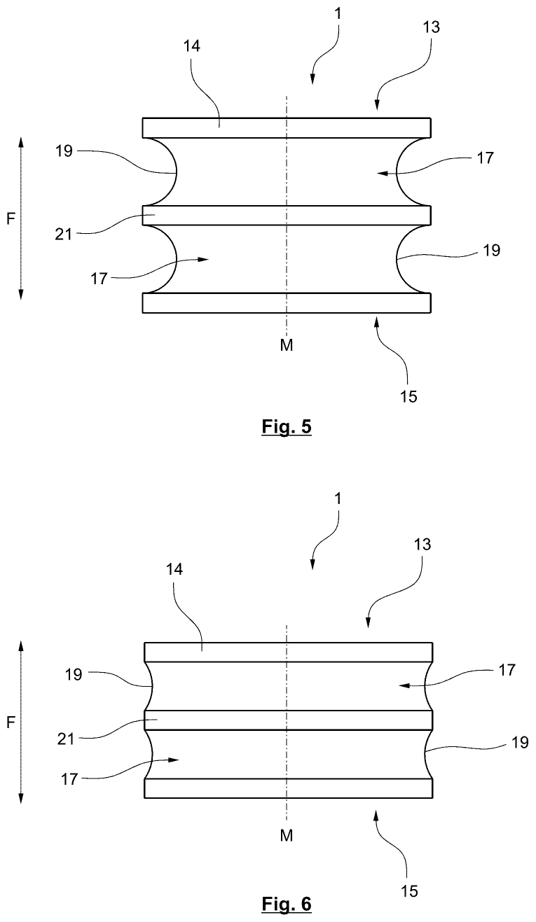

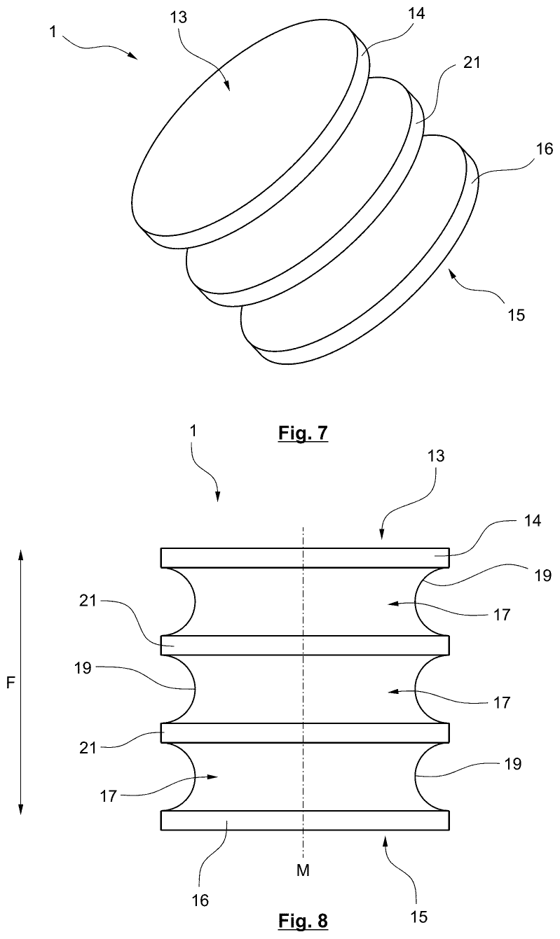

With reference to FIGS. 5 to 7, the structure of an elastomer spring 1 according to the disclosure is described in detail below. FIG. 5 shows a side view of the elastomer spring 1 in the untensioned state, as shown in FIG. 3, and FIG. 7 shows a perspective view. FIG. 6 shows the elastomer spring 1 in the tensioned state, as shown in FIG. 4.

An elastomer spring 1 according to the disclosure comprises an elastomer body 2 made from one piece, which can be produced for example by polymerisation, polycondensation, polyaddition or vulcanisation. The elastomer material may, for example, be a cast elastomer, in particular polyurethane, such as Urelast. The elastomer body 2 can elastically deform and compress in the spring direction F. The elastomer body 2 is rotationally shaped and axially symmetrical with respect to a center axis M, which also defines the spring direction F.

The elastomer spring 1 has an upper side 13 facing in the spring direction F of the elastomer body 2 and a lower side 15 facing in the spring direction F of the elastomer body 2, which is opposite the upper side 13. The upper side 13 and the lower side 15 are each realized as planar disks 14, 16 and serve to transmit spring forces in the spring direction F. The embodiment of the elastomer spring 1 in FIGS. 5 to 7 also comprises two identically shaped preload components 17, which connect the upper side 13 and the lower side 15 of the elastomer body 2 to one another and each have a lateral surface 19 which is concavely curved when viewed from the outside. The preload components 17 are arranged in series as viewed in the spring direction F. Between the two preload components 17 there is a planar cutting disc 21 which separates the two preload components 17 from each other. The cutting disc 21 has the same shape and the same outer dimensions as the discs 14, 16 on the upper side 13 and the lower side 15 of the elastomer body 2. The discs 14, 16 on the upper side 13 and the lower side 15, the preload components 17 and the cutting disc 21 are made in one piece according to the disclosure.

By comparing FIG. 5 and FIG. 6 and by looking at FIGS. 3 and 4, the function of the elastomer spring 1 according to the disclosure can be seen. During compression, the disks 14,16 on the upper side 13 and the lower side 15 of the elastomer body 2 or the cutting disc 21 are moved towards each other between the two preload components 17. The discs 14,16 or the cutting disc 21 remain undeformed. This causes the preload components 17 between the disks 14,16,21 to compress elastically, resulting in a bellows or concertina-like structure of the elastomer spring 1. The compression of the preload components 17 decreases the curvature of the respective lateral surface 19, because the elastomer material of the preload components 17 is displaced radially outwards. This is why the curvature of the lateral surfaces 19 of the preload components 17 is smaller in the compressed state of the elastomer spring 1 in FIG. 6 and FIG. 4 than in the relaxed state of the elastomer spring 1 in FIG. 5 and FIG. 3. When the elastomer spring 1 is no longer compressed, the disks 14,16 on the upper side 13 and the lower side 15 or the cutting disc 21 move away from each other again during the extension, so that the preload components 17 expand again and the curvature of the lateral surfaces 19 increases. The two preload components 17 can be compressed and expanded independently of each other by the cutting disc 21, so that different curvatures of the two lateral surfaces 19 are also possible.

During compression, the compression of the preload components 17 builds up an elastic deformation restoring force, which can be transmitted by the elastomer body 2 via the disks 14,16 on the upper side 13 and the lower side 15 as a preload force in the spring direction F. This preload force can, for example, generate the frictional force required in an azimuth brake 10 to brake the nacelle 103 of a wind turbine. In FIG. 3, the disks 14,16,21 are far apart so that the preload components 17 are not compressed and the elastomer spring 1 is relaxed. Therefore, no deformation restoring force and thus no preload force is generated. In FIG. 4, for braking, first the elastomer spring 1 and the sliding disk 3 immediately above it in the vertical direction are pushed in the direction of the azimuth ring 105 by screwing the screw 9 into the recess 7. When there is contact between the sliding disk 3 and the azimuth ring 105, i.e. when the gap 12 between the sliding disk 3 and the azimuth ring 105 is closed, the disks 14,16,21 of the elastomer spring 1 move towards each other so that the intermediate preload components 17 are compressed and the curvature of the lateral surfaces 19 decreases. This creates a deformation restoring force that can be used as a preload force. Since the lower side 15 of the elastomer spring 1 in the embodiment in FIG. 4 is in firm contact with the disk 11 connected to the screw 9 and consequently cannot move, the preload force is transmitted via the upper side 13 of the elastomer spring 1 to the sliding disk 3, which is thereby pressed against the azimuth ring 105. This creates a frictional force between the sliding disk 3 and the azimuth ring 105, which brakes the receptacle 5 in which the elastomer spring 1 is housed and the nacelle 103 of the wind turbine connected to it.

Due to the concave curved lateral surface 19 of the preload components 17, the elastomer spring 1 can be subjected to very high loads because a viscoelastic effect can be used. In addition, the necessary installation space and material costs can be reduced compared to elastomer springs with a cylindrical cross-section. The concavely curved lateral surface 19 of the preload components 17 also creates a larger yielding space for the elastomer material of the preload components 17, so that the deformation rate or the degree of compression of the elastomer spring 1 is increased. To adjust the degree of compression or expansion of the preload components 17 and thus of the elastomer spring 1, both the dimensions in the axial direction and radial direction of the elastomer body 2 or the preload components 17 and the radius of curvature of the lateral surfaces 19 of the preload components 17 are relevant.

With reference to FIG. 3 and FIG. 4, it can be seen that the disks 14,16 on the upper side 13 and the lower side 15 and the cutting disc 21 are clamping sections which form a circumferential contact with the receptacle 5 and the cylindrical recess 7 respectively and thus center and fix the elastomer spring 1 in the recess 7. The clamping sections 14,16,21 thus determine the maximum dimension of the elastomer spring 1 transversely to the spring direction F. When the elastomer spring 1 is compressed, the clamping sections 14,16,21 slide along the inner surfaces 23 of the recess 7. Furthermore, it can be seen that the elastomer material of the preload components 17 can expand or yield into a yielding space resulting between the inner wall 23 of the recess 7 and the lateral surface 19 when the elastomer spring 1 is compressed.

FIG. 8 shows a further exemplary embodiment of an elastomer spring 1 according to the disclosure in a side view. In the embodiment shown in FIG. 8, the upper side 13 and the lower side 15 of the elastomer body 2 are connected by three identically shaped preload components 17, each with a concave lateral surface 19. Two adjacent preload components 17 are separated from each other by a cutting disc 21. It is also possible for an elastomer spring 1 according to the disclosure to have more than three preload components 17 or only a single preload component 17 between the upper side 13 and the lower side 15 of the elastomer body 2.

The features disclosed in the foregoing description, the figures and the claims may be significant both individually and in any combination for the realization of the disclosure in the various embodiments.

### REFERENCE LIST

1 Elastomer spring
10 Azimuth brake
100 Azimuth drive
2 Elastomer body
3 Sliding disk
5 Receptacle
6 Upper side of the receptacle
7 cylindrical recess
8 Lower side of the receptacle
9 Screw
11 Disk
12 Gap
13 Upper side
14 Disk
15 Lower side
16 Disk
17 Preload component
19 Lateral surface
21 Cutting disc
23 Inner surface
25 Recess base
101 Tower
103 Nacelle
105 Azimuth ring
106 Gear wheel
107 Electric motor
108 Upper side of the azimuth ring
110 Lower side of the azimuth ring

1. An elastomer spring for an azimuth brake of an azimuth drive adapted to track a nacelle with a rotor relative to a tower of a wind turbine, the elastomer spring comprising:
an elastomer body made from one piece and including upper and lower sides each pointing in a spring direction of the elastomer body and being adapted to transmit a spring force in the spring direction; and
a preload component connecting the upper and lower the sides, the preload component having a concavely curved lateral surface.

2. The elastomer spring according to claim 1, wherein the preload component is adapted to elastically compress during compression such that a curvature of the lateral surface decreases.

3. The elastomer spring according to claim 1, wherein the preload component is adapted to expand during deflection such that a curvature of the lateral surface increases.

4. The elastomer spring according to claim 1, wherein the preload component is adapted to elastically compresses during compression, building up an elastic deformation restoring force, such that the elastomer body is adapted to transmit the deformation restoring force as a preload force in the spring direction via the upper and the lower sides.

5. The elastomer spring according to claim 1, wherein the elastomer body includes at least one further preload components, wherein the preload components and the at least one further preload component are arranged in series in the spring direction.

6. The elastomer spring according to claim 5, wherein two adjacent preload components, of the preload component and the at least one further preload component, are separated from each other by a cutting disc adapted to remain undeformed during compression and/or extension.

7. The elastomer spring according to claim 6, wherein the cutting disc has a same shape and/or outer dimension as the upper and the lower sides.

8. An azimuth brake for an azimuth drive adapted to track a nacelle with a rotor relative to a tower of a wind turbine, the azimuth drive having an azimuth ring connected to the tower in a rotationally fixed manner, the azimuth brake comprising:
a sliding disk in sliding contact with the azimuth ring of the azimuth drive; and
an elastomer spring adapted to preload the sliding disk against the azimuth ring, wherein the elastomer spring includes:
an elastomer body made from one piece and including upper and lower sides each pointing in a spring direction of the elastomer body and being adapted to transmit a spring force in the spring direction; and
a preload component connecting the upper and lower the sides, the preload component having a concavely curved lateral surface.

9. The azimuth brake according to claim 8, further comprising: a nacelle-fixed receptacle adapted for the elastomer spring such that the elastomer spring is translationally displaceable.

10. The azimuth brake according to claim 9, wherein the elastomer spring includes at least two clamping sections arranged at a distance from one another in the spring direction of the elastomer spring, the at least two clamping sections being in circumferential contact with the receptacle and being connected to one another via a concavely curved lateral surface.

11. The azimuth brake according to claim 10, wherein the at least two clamping sections are supported on the receptacle when the elastomer spring is is compressed to increase the preload force on the sliding disk such that the at least to clamping sections are moved towards each other and the curvature of the lateral surface decreases.

12. The azimuth brake according to claim 8, wherein the preload force is adjustable via a degree of compression of the elastomer spring.

13. The azimuth brake according to claim 8, further comprising a mechanical, hydraulic, or pneumatic unit adapted to compress the elastomer spring.

14. An azimuth drive adapted to track a nacelle having a rotor relative to a tower of a wind turbine, the azimuth drive comprising:
at least one servomotor; and
an azimuth brake according to claim 8.

15. The azimuth brake according to claim 8, wherein the elastomer spring is made of a cast elastomer.

16. The azimuth brake according to claim 15, wherein the elastomer spring is polyurethane.

17. The azimuth brake according to claim 9, wherein the nacelle-fixed receptacle adapted for the elastomer spring such that the elastomer spring and the sliding disk is translationally displaceable.
